(19) United States
(12) Patent Application Publication
(10) Pub. No.: US 2003/0212193 A1
(43) Pub. Date: Nov. 13, 2003

(54) Propylene-based polymer and injection molded article made of the same

(75) Inventors: Takeshi Maruyama, Sodegaura-shi (JP); Hiroyuki Tanimura, Sodegaura-shi (JP); Kenichi Okawa, Ichihara-shi (JP)

Correspondence Address: SUGHRUE MION, PLLC, 2100 Pennsylvania Avenue, NW, Washington, DC, 20037-3213, US

(73) Assignee: SUMITOMO CHEMICAL COMPANY, LIMITED

(21) Appl. No.: 10/386,682

(22) Filed: Mar. 13, 2003

(30) Foreign Application Priority Data
Mar. 26, 2002 (JP) 2002-086177
Mar. 29, 2002 (JP) 2002-093597

(51) Int. Cl. C08F 210/00

(52) U.S. Cl. 524/543; 526/348

(57) ABSTRACT

Disclosed are a propylene-based polymer and an injection molded article made of the propylene-based polymer, both of which are superior in transparency and impact resistance wherein the propylene based polymer satisfies requirements (a) and (b) defined below:

(a) the proportion of a fraction soluble in xylene at 20° C. (CXS) relative to the whole propylene-based polymer is from 5 to 20% by weight; and

(b) the CXS has a molecular weight distribution (Mw/Mn), as measured by gel permeation chromatography, of 6 or more wherein Mw indicates a weight average molecular weight and Mn indicates a number average molecular weight. Also disclosed are a propylene-based resin composition and an injection molded article made of the composition, the composition comprising 100 parts by weight of the above propylene-based polymer and 0.001-2 parts by weight of a nucleating agent.

### BACKGROUND OF THE INVENTION

1. Field of the Invention

The present invention relates to a propylene-based polymer suitable as a material for injection molding and to an injection molded article made of the same. In particular, the invention relates to a propylene-based polymer that is suitable as a material for injection molding because of its superior transparency and superior impact resistance, and to an injection molded article made of the same.

2. Description of the Related Art

Polypropylene resin is widely used in applications such as containers (e.g. foodstuff containers and medical containers), home appliances, external components of household electrical appliances and automotive components because of the fact that it is superior, for example, in rigidity, processing stability and formability and is inexpensive. As a conventional approach for improving the impact resistance is to blend polyethylene or a rubbery elastic substance, e.g. ethylene-propylene copolymer rubber, ethylene-butene copolymer rubber and ethylene-propylene-diene copolymer rubber, to a polypropylene resin. However, a resulting blend may have a transparency inferior to that of a polypropylene resin before blending. In addition, a rubbery elastic substance can not be used in the form of pellets form depending upon its composition. This may cause some troubles in blending operations.

Disclosed in JP, 10-7727,A as a low crystalline polypropylene which is unsticky and superior in both flexibility and transparency is such a polypropylene resin that the MFR is from 0.1 to 1000 g/10 min, that the amount of the 23° C. xylene-soluble fraction (CXS) is from 0.5 to 5.0%by weight, that the main endothermic peak temperature of the dissolution curve is from 153 to 163° C., that the amount of the fraction eluted at temperatures not higher than 80° C. determined by cross-fraction chromatography (CFC) is from 0.01 to 3.0% by weight, and that the isotactic pentad fraction (mmmm) is from 92.0 to 98.0%. However, the impact resistance of the polypropylene resin disclosed in that specification may be insufficient depending upon its applications.

Under such situations, the improvement of propylene resin in its transparency and impact resistance has been desired.

### SUMMARY OF THE INVENTION

An object of the present invention is to provide a propylene-based polymer suitable as a material for injection molding, specifically, a propylene-based polymer that is suitable as a material for injection molding because of its superior transparency and superior impact resistance. Another object of the present invention is to provide an injection molded article that is made of a propylene-based polymer and is superior in transparency and impact resistance.

Considering such actual situations, the present inventors investigated diligently and found that the above-mentioned problem can be solved by a propylene-based polymer wherein the amount of a so-called 20° C. xylene-soluble fraction (CXS) is within a specific range and a molecular weight distribution, as measured by gel permeation chromatography, of the CXS is also within a specific range. Thus, they accomplished the present invention.

That is, the present invention relates to a propylene-based polymer and to an injection molded article made of the propylene-based polymer, the polymer satisfying requirements (a) and (b) defined below:

(a) the proportion of a fraction soluble in xylene at 20° C. (CXS) relative to the whole propylene-based polymer is from 5 to 20% by weight; and

(b) the CXS has a molecular weight distribution (Mw/Mn), as measured by gel permeation chromatography, of 6 or more wherein Mw indicates a weight average molecular weight and Mn indicates a number average molecular weight.

In addition, the present invention also relates to a propylene-based resin composition and to a injection molded article made of the propylene-based resin composition, the composition comprising a propylene-based polymer satisfying requirements (a) and (b) defined below and from 0.001 to 2 parts by weight, based on 100 parts by weight of the propylene-based polymer, of a nucleating agent:

(a) the proportion of a fraction soluble in xylene at 20° C. (CXS) relative to the whole propylene-based polymer is from 5 to 20% by weight; and

(b) the CXS has a molecular weight distribution (Mw/Mn), as measured by gel permeation chromatography, of 6 or more wherein Mw indicates a weight average molecular weight and Mn indicates a number average molecular weight.

### DESCRIPTION OF PREFERRED EMBODIMENTS

The propylene-polymer contains a fraction soluble in xylene at 20° C., that is, so-called 20° C. xylene-soluble fraction (CXS) and the proportion of the CXS relative to the whole propylene-based polymer is from 5 to 20% by weight, preferably from 5 to 15% by weight, more preferably from 6 to 15% by weight. When the amount of the 20° C. xylene-soluble fraction is less than 5% by weight, the impact resistance of an injection molded article may be insufficient. When it is over 20% by weight, the rigidity may deteriorate.

The propylene-based polymer for injection molding of the present invention has a molecular weight distribution (Mw/Mn), as measured by gel permeation chromatography (GPC), of 6 or more, preferably from 6 to 15, and more preferably from 6 to 12. When the molecular weight distribution (Mw/Mn) of the CXS is less than 6, the transparency and the impact resistance may be insufficient. It is noted that Mw and Mn indicate a weight average molecular weight and a number average molecular weight, respectively.

The propylene-based polymer of the present invention has a melt flow rate (MFR) at 230° C. of from 0.5 to 500 g/10 min and, in view of the flowability during injection molding, preferably from 10 to 100 g/10 min, more preferably from 20 to 80 g/10 min.

The propylene-based polymer of the present invention includes homopolymers of propylene and copolymers of propylene with ethylene and/or α-olefin having from 4 to 20 carbon atoms. Examples of the α-olefin having from 4 to 20 carbon atoms include butene-1, pentene-1, hexene-1, 4-methylpentene-1, heptene-1, octene-1 and decene-1. These α-olefins may be used alone or in combination of two or more of them.

Examples of the copolymers of propylene with ethylene and/or α-olefin having from 4 to 20 carbon atoms include propylene-ethylene copolymers, propylen-butene-1 copolymers, propylene-ethylene-butene-1 copolymers, propylene-hexene-1 copolymers and propylene-ethylene-hexene-1 copolymers. Preferred are propylene-ethylene copolymers, propylene-butene-1 copolymers and propylene-ethylene-butene-1 copolymers.

The propylene-based polymer for injection molding of the present invention preferably includes crystalline propylene homopolymers and crystalline copolymers of propylene with ethylene and/or α-olefin having from 4 to 20 carbon atoms.

Examples of the crystalline copolymers of propylene with ethylene and/or α-olefin having from 4 to 20 carbon atoms include crystalline propylene-ethylene copolymers, crystalline propylen-butene-1 copolymers, crystalline propylene-ethylene-butene-1 copolymers, crystalline propylene-hexene-1 copolymers and crystalline propylene-ethylene-hexene-1 copolymers. Preferred are crystalline propylene-ethylene copolymers, crystalline propylene-butene-1 copolymers and crystalline propylene-ethylene-butene-1 copolymers.

The content of ethylene and/or α-olefin having from 4 to 20 carbon atoms in the crystalline copolymers of propylene with ethylene and/or α-olefin having from 4 to 20 carbon atoms is usually from 0.01 to 15% by weight and, in view of rigidity, preferably from 0.01 to 10% by weight, more preferably from 0.01 to 5% by weight.

The method for producing the propylene-based polymer for injection molding of the present invention may be conventionally known method for the production of propylene-based polymers. Examples of preferable methods include methods in which known slurry polymerization, solution polymerization, or liquid phase or gas phase polymerization using olefin monomers as a medium is used in the presence of a stereoregulating catalyst obtained by a specific method disclosed in JP, 7-216017,A, the catalyst comprising a trivalent titanium compound-containing solid catalyst component, an organoaluninum compound and an electron donating compound. For example, when the method disclosed in JP, 7-216017,A is applied, the amount of the electron donating compound used herein is usually from 0.01 to 500 mol, preferably from 0.01 to 100 mol, and particularly preferably from 0.01 to 50 mol per mol of titanium atoms contained in the solid catalyst component.

The intrinsic viscosity of the propylene-based polymer of the present invention is usually from 0.5 to 4 dl/g and, in view of formability, preferably from 1 to 3 dl/g, and more preferably from 1 to 2 dl/g.

When the propylene-based polymer of the present invention is used, polyolefin polymers, e.g. polyethylene, polybutene-1, styrene-based resin, ethylene-α-olefin copolymer rubber and ethylene-propylene-diene copolymer rubber may, as needed, be added to the propylene-based polymer.

When the propylene-based polymer of the present invention is used, other additives, e.g. antioxidants, neutralizing agents, weatherproofing agents, flame retardants, antistatic agents, plasticizers, lubricants and copper inhibitors may, as needed, be added to the propylene-based polymer.

For example, a propylene-based resin composition comprising the above-mentioned propylene-based polymer of the present invention and a proper amount of a nucleating agent is suitable as a material for injection molding. The blending of the nucleating agent improves the crystallization speed of the propylene-based polymer, resulting in a propylene-based resin composition with a superior high-speed moldability. In addition, that blending also contributes to provide a molded article which is superior in rigidity and heat resistance and also particularly superior in transparency.

Specifically, provided is a propylene-based resin composition comprising a propylene-based polymer satisfying requirements (a) and (b) defined below and from 0.001 to 2 parts by weight, based on 100 parts by weight of the propylene-based polymer, of a nucleating agent:

(a) the proportion of a fraction soluble in xylene at 20° C. (CXS) relative to the whole propylene-based polymer is from 5 to 20% by weight; and

(b) the CXS has a molecular weight distribution (Mw/Mn), as measured by gel permeation chromatography (GPC), of 6 or more wherein Mw indicates a weight average molecular weight and Mn indicates a number average molecular weight.

The nucleating agent used in the present invention may be a known nucleating agent, examples of which include sorbitol-based nucleating agents, organophosphorus acid-based nucleating agents, aromatic carboxylic acid-based nucleating agents, high-melting polymer-based nucleating agents, rhodinic acid-based nucleating agents, amide-based nucleating agents and inorganic nucleating agents. These may be used alone or in combination of at least two of them.

Examples of the nucleating agent used in the present invention include sorbitol-based nucleating agents, e.g. 1,3,2,4-di(p-methylbenzylidene)sorbitol, 1,3-o-methylbenzylidene 2,4-p-methylbenzylidene sorbitol, 1,3,2,4-dibenzylidene sorbitol, 1,3,2,4-di-(p-ethylbenzylidene) sorbitol and 1,3,2,4-di-(2′,4′-dimethylbenzylidene) sorbitol; or organophosphorus acid-based nucleating agents, e.g. hydroxyaluminum-bis [2,2′-methylene-bis(4,6-dimethylphenyl) phosphate], hydroxyaluminum-bis[2,2′-ethylidene-bis(4,6-dimethylphenyl) phosphate], hydroxyaluminum-bis[2,2′-methylene-bis(4,6-diethylphenyl) phosphate], hydroxyaluminum-bis[2,2′-ethylidene-bis(4,6-diethylphenyl) phosphate], hydroxyaluminum-bis[2,2′-methylene-bis(4,6-di-tert-butylphe nyl) phosphate], hydroxyaluminum-bis[2,2′-ethylidene-bis (4,6-di-tert-butylphenyl) phosphate], hydroxyaluminum-bis [2,2′-methylene-bis(4-methyl-6-tert-butylphenyl) phosphate], hydroxyaluminum-bis[2,2′-ethylidene-bis(4-methyl-6-tert-but ylphenyl) phosphate], hydroxyaluminum-bis[2,2′-methylene-bis(4-ethyl-6-tert-butyl phenyl) phosphate], hydroxyaluminum-bis[2,2′-ethylidene-bis(4-ethyl-6-tert-buty lphenyl) phosphate], hydroxyaluminum-bis [2,2′-methylene-bis(4-isopropyl-6-tert-butylphenyl) phosphate], and hydroxyaluminum-bis[2,2′-ethylidene-bis(4-isopropyl-6-tert-butylphenyl) phosphate]. Preferred are hydroxyaluminum-bis[2,2′-methylene-bis(4,6-di-tert-butylphe nyl) phosphate], hydroxyaluminum-bis[2,2′-ethylidene-bis(4,6-di-tert-butylph enyl) phosphate], 1,3,2,4-di(p-methylbenzylidene) sorbitol, and 1,3-o-methylbenzylidene 2,4-p-methylbenzylidene sorbitol.

The content of the nucleating agent used in the present invention is from 0.001 to 2 parts by weight, preferably from 0.01 to 1 part by weight, based on 100 parts by weight of the propylene-based polymer satisfying requirements (a) and (b) used in the present invention. A content less than 0.01 part by weight may result in an insufficient effect as a nucleating agent, whereas a content over 2 parts by weight results in a saturated effect to a propylene-based polymer as a nucleating agent, leading only to poor economy.

The propylene-based resin composition may, as needed, contain polyolefin polymers, e.g. polyethylene, polybutene-1, styrene-based resin, ethylene-α-olefin copolymer rubber and ethylene-propylene-diene copolymer rubber.

The propylene-based resin composition may, as needed, contain additives other than the nucleating agent, e.g. antioxidants, neutralizing agents, weatherproofing agents, flame retardants, antistatic agents, plasticizers, lubricants and copper inhibitors.

The method for mixing the above-mentioned polyolefin polymers or additives with the propylene-based polymer of the present invention may be conventionally known methods. Examples thereof include methods comprising mixing a propylene-based polymer for injection molding and the aforementioned polyolefin polymers or additives, which are added as needed, with a mixer such as a tumbler mixer, a Henschel mixer and a ribbon blender and then uniformly melt-kneading using a single screw extruder, a twin screw extruder and a Banbury mixer.

Injection molded articles made of the propylene-based polymer or propylene-based resin composition of the present invention can be used for applications in which transparency and impact resistance are required. Particularly preferable applications are containers (e.g. foodstuff containers and medical containers), home appliances and clothes cases.

### EXAMPLES

The present invention will be described concretely below with reference to examples and comparative examples. However, the invention is not limited to these examples.

The physical properties in the examples and the comparative examples were measured by the methods described below.

(1) Intrinsic Viscosity ([η]) (Unit: dl/g)

Reduced viscosities at three concentrations of 0.1, 0.2 and 0.5 dl/g were determined using an Ubbelohde's viscometer. An intrinsic viscosity was determined by the calculation method described in “Kobunshi Yoeki, Kobunshi Jikkengaku 11” (published by Kyoritsu Shuppan Kabushiki Kaisha, 1982), page 491, that is, by an extrapolation method by which reduced viscosities are plotted against concentrations and the curve is extrapolated to zero concentration. Tetralin was used as a solvent and measurement was conducted at a temperature of 135° C.

(2) 20° C. Xylene-Soluble Fraction (CXS) (Unit: % by Weight)

5 g of sample was dissolved completely in 500 ml of boiling xylene and then cooled to 20° C., followed by being left stand for 4 hours. Thereafter, the mixture was separated into a precipitate and a solution by filtration. A solvent was removed from the filtrate and the residue was dried at 70° C. under reduced pressure. The dried residue was weighed and the content of a 20° C. xylene-soluble fraction was calculated.

(3) Ethylene Content (Unit: % by Weight)

Measurement was carried out using an IR spectrum in accordance with the method described in Kobunshi Bunseki (Polymer Molecule Analysis) Handbook, page 256 [(i) Random Copolymer], published by Asakura Shoten, 1985.

(4) Melting Point (Tm, ° C.)

Measurement was carried out using a differential scanning calorimeter (DSC model VII, manufactured by PerkinElmer Inc.) Measurement conditions are as follows. First, 10 mg of specimen was in advance placed under a nitrogen atmosphere and was molten at 220° C. for 5 minutes. The temperature was dropped to 50° C. at a rate of 5° C./min to solidify the melt. Subsequently, the temperature was raised at a rate of 5° C./min and a temperature of a maximum peak of a resulting melt endothermic curve was used as a melting point.

(5) Molecular Weight Distribution (Mw/Mn)

Measurement was carried out using gel permeation chromatography (GPC) under the conditions shown below. A calibration curve was made using a standard polystyrene.

Apparatus: Model 150CV manufactured by Millipore-Waters

Column: Shodex M/S 80

Measuring temperature: 145° C.

Solvent: Orthodichlorobenzene

Sample concentration: 5 mg/8 ml

When a Standard Reference Material 706 (polystyrene of MW/Mn=2.1) available from NBS (National Bureau of Standards) was measured under those conditions, a molecular weight distribution (Mw/mn) of 2.1 was obtained.

(6) Melt Flow Rate (MFR, Unit: g/10 min)

Measurement was carried out at 230° C. according to JIS K7210.

(7) Impact Strength (FWI, Unit: kg·cm)

Used as specimens were pieces obtained by punching circular plates 65 mm in diameter out of a disc-shaped injection molded article 220 mm in diameter and 1.2 mm in thickness resulting from injection molding described later. After conditioning of the specimen at 23° C. at 50% RH for 48 hours or longer, a weight was fallen onto a target area ½ inch in diameter in a fixed specimen from a specific height. A value of energy (kg-cm) consumed when 50% of the number of the specimens ruptured was determined. The impact strength was evaluated using a falling weight impact strength. A larger value of FWI indicates a better impact resistance.

(8) Flexural Modulus (FM, Unit: MPa)

Measurement was carried out according to JIS K7203. Used as a specimen was one obtained by injection molding as described below. The flexural modulus was measured under conditions: thickness of a specimen=6.4 mm, span length=100 mm, load speed=2.5 mm/min, and measuring temperature=23° C. The flexural modulus is an index of rigidity. A larger flexural modulus indicates a superior rigidity.

(9) Transparency (Haze, unit: %)

Measurement was conducted according to JIS K7150. Used as a specimen was a piece obtained by cutting a portion within about 6 cm from a center of a disc-shaped injection molded article 220 mm in diameter and 1.2 mm in thickness, which is described below, into a 3 cm×3 cm square. A higher haze value indicates that the specimen visually looks whitish as a mist hangs and the transparency is poorer. Physical properties of the injection molded article obtained are shown in Table 1. The physical properties in the table were measured according to the methods described above.

(1-1) Synthesis of Solid Catalyst Component (A)

Following replacement of the atmosphere in a 200-L SUS reactor equipped with a stirrer by nitrogen, 80 L of hexane, 6.55 mol of tetrabutoxytitanium, 2.8 mol of isobutyl phthalate and 98.9 mol of tetraethoxysilane were feed to form a homogeneous solution. Then, 51 L of a butylmagnesium chloride solution in diisobutyl ether at a concentration of 2.1 mol/L was dropped slowly over 5 hours while holding the temperature in the reactor at 5° C. After the dropping, the mixture was stirred at 5° C. for 1 hour and at room temperature for additional 1 hour. Subsequently, solid-liquid separation was performed at room temperature and washing with 70-L toluene was repeated three times. Then, the amount of toluene was adjusted so that the slurry concentration became 0.2 Kg/L, followed by stirring at 105° C. for 1 hour. Then, the mixture was cooled to 95° C. and 47.5 mol of diisobutyl phthalate was added, followed by a reaction at 95° C. for 30 minutes. After the reaction, solid-liquid separation was performed and washing with toluene was repeated twice. Then, the amount of toluene was adjusted so that the slurry concentration became 0.4 Kg/L, 3.1 mol of diisobutyl phthalate, 8.9 mol of di-n-butyl ether and 274 mol of titanium tetrachloride were added, followed by a reaction at 105° C. for 3 hours. After the completion of the reaction, solid-liquid separation was performed and washing with 90-L toluene at that temperature was carried out twice. The amount of toluene was adjusted so that the slurry concentration became 0.4 Kg/L, 8.9 mol of di-n-butyl ether and 137 mol of titanium tetrachloride were added, followed by a reaction at 105° C. for 1 hour. After the completion of the reaction, solid-liquid separation was performed at that temperature and washing with 90-L toluene at the same temperature was carried out three times. After additional three-time washing with 70-L hexane, the residue was dried under reduced pressure, yielding 11.4 Kg of solid catalyst component (A), which contained 1.83% by weight of titanium atom, 8.4% by weight of phthalate, 0.30% by weight of ethoxy group and 0.20% by weight of butoxy group. An observation of solid catalyst component (A) through a stereomicroscope confirmed that the component had a superior particle form free of fine powder.

(1-2) Polymerization of Crystalline Propylene-Ethylene Copolymer (PP1)

(a) Preliminary Polymerization

A fully purified hexane was added to a 2.5-L reactor equipped with a stirrer and the atmosphere in the system was fully replaced by nitrogen. Subsequently, triethylaluminum (henceforth abbreviated TEA), n-propylmethyldimethoxysilane (henceforth abbreviated nPMDMS) and solid catalyst component (A) obtained in the above-mentioned Referential Example 1 (1-1) were added so that nPMDMS/Ti=0.175 (mol/mol) and TEA/Ti=3.50 (mol/mol) and also propylene was added over 30 minutes while maintaining the temperature at 5-15° C., yielding a preliminary polymer slurry.

(b) Main Polymerization

Using a 1100-L gas phase fluidized bed polymerization tank equipped with a stirrer, a continuous gas phase polymerization was carried out while feeding a slurry of the above-mentioned preliminary polymer, TEA, which was supplied so that the amount thereof became to 100-350 ppm relative to the polymer to be produced, and nPMDMS (nPMDMS/Ti=2.37 (mol/mo/) under conditions where propylene, ethylene and hydrogen are fed so as to maintain a polymerization temperature at 80° C., a polymerization pressure at 1.8 MPa, a concentration of ethylene in the gas phase at 0.9 vol % and a concentration of hydrogen in the gas phase at 1.7 vol %. Thus, a crystalline propylene-ethylene copolymer (PP1) in the form of a resin powder was obtained. The resulting crystalline propylene-ethylene copolymer (PP1) had an ethylene content of 2.3% by weight, a CXS of 7.4% by weight, an intrinsic viscosity [η] of 1.14 dl, and a Tm of 145.0° C.

### Referential Example 2

(2-1) Polymerization of Crystalline Propylene-Ethylene Copolymer (PP2)

Crystalline propylene homopolymer (PP2) in the form of a resin powder was obtained in the same manner as Referential Example 1 except the following changes: in (1-2) (a) Preliminary Polymerization of Referential Example 1, nPMDMS to tert-butyl-n-propyldimethoxysilane (henceforth abbreviated tBnPDMS), the feed amount thereof to tBnPDMS/TEA=0.07 (mol/mol); and in (b) Main Polymerization, the feed amount of nPMDMS to nPMDMS/Ti=5.72 (mol/mol), the concentration of ethylene in the gas phase to 2.06 vol % and the concentration of hydrogen in the gas phase to 2.16 vol %. The resulting crystalline propylene-ethylene copolymer (PP2) had an ethylene content of 4.9% by weight, a CXS of 10.7% by weight, an intrinsic viscosity [η] of 1.25 dl, and a Tm of 137.4° C.

### Referential Example 3

(3-1) Preparation of Solid Catalyst Component (B)

Following replacement of the atmosphere in a 200-L SUS reactor equipped with a stirrer by nitrogen, 80 L of hexane, 6.55 mol of tetrabutoxytitanium and 98.9 mol of tetraethoxysilane were feed to form a homogeneous solution. Then, 50 L of a butylmagnesium chloride solution in diisobutyl ether at a concentration of 2.1 mol/L was dropped slowly over 4 hours while holding the temperature in the reactor at 20° C. After the dropping, the mixture was stirred at 20° C. for additional 1 hour. Subsequently, solid-liquid separation was performed at room temperature and washing with 70-L toluene was repeated three times. Then, toluene was removed so that the slurry concentration became 0.4 Kg/L and subsequently a mixed solution comprising 8.9 mol of di-n-butyl ether and 274 mol of titanium tetrachloride was added. Furthermore, 20.8 mol of phthalate was added and a reaction was carried out at 110° C. for 3 hours. After the completion of the reaction, washing with 95° C. toluene was carried out three times. Subsequently, the slurry concentration was adjusted to 0.4 Kg/L and then 3.13 mol of diisobutyl phthalate, 8.9 mol of di-n-butyl ether and 109 mol of titanium tetrachloride were added, followed by a reaction at 105° C. for 1 hour. After the completion of the reaction, solid-liquid separation was carried out at that temperature and washing with 95° C. toluene was carried out twice. Subsequently, the slurry concentration was adjusted to 0.4 Kg/L and then 8.9 mol of di-n-butyl ether and 109 mol of titanium tetrachloride were added, followed by a reaction at 95° C. for 1 hour. After the completion of the reaction, solid-liquid separation was carried out at that temperature and washing with 90-L toluene was carried out twice. Subsequently, the slurry concentration was adjusted to 0.4 Kg/L and then 8.9 mol of di-n-butyl ether and 109 mol of titanium tetrachloride were added, followed by a reaction at 95° C. for 1 hour. After the completion of the reaction, solid-liquid separation was carried out at that temperature and washing with 90-L toluene was repeated three times at that temperature. After additional three-time washing with 90-L hexane, the residue was dried under reduced pressure, yielding 12.8 Kg of solid catalyst component (B), which contained 2.1% by weight of titanium atom, 18% by weight of magnesium atom, 60% by weight of chlorine atom, 7.15% by weight of phthalate, 0.05% by weight of ethoxy group and 0.26% by weight of butoxy group and also had a superior particle form free of fine powder.

(3-2) Polymerization of Crystalline Propylene-Ethylene Copolymer (PP3)

(a) Preliminary Polymerization

A fully purified hexane was added to a 2.5-L reactor equipped with a stirrer and the atmosphere in the system was fully replaced by nitrogen. Subsequently, triethylaluminum (henceforth abbreviated TEA), cyclohexylethyldimethoxysilane (henceforth abbreviated CHEDMS) and solid catalyst component (B) obtained in the above-mentioned Referential Example 3 were added so that CHEDMS/Ti=0.2 (mol/mol) and TEA/Ti=4.0 (mol/mol) and also propylene was added over 30 minutes while maintaining the temperature at 5-15° C., yielding a preliminary polymer slurry.

(b) Main Polymerization

Using a 1100-L gas phase fluidized bed polymerization tank equipped with a stirrer, a continuous gas phase polymerization was carried out while feeding a slurry of the above-mentioned preliminary polymer and TEA under conditions where propylene, ethylene and hydrogen are fed so as to maintain a polymerization temperature at 80° C., a polymerization pressure at 1.8 MPa, a concentration of ethylene in the gas phase at 1.19 vol % and a concentration of hydrogen in the gas phase at 1.83 vol %. Thus, a crystalline propylene-ethylene copolymer (PP3) in the form of a resin powder was obtained. The resulting crystalline propylene-ethylene copolymer (PP3) had an ethylene content of 2.5% by weight, a CXS of 7.8% by weight, an intrinsic viscosity [η] of 1.19 dl, and a Tm of 148.8° C.

### Referential Example 4

(4-1) Polymerization of Crystalline Propylene-Ethylene Copolymer (PP4)

Crystalline propylene homopolymer (PP3) in the form of a resin powder was obtained in the same manner as Referential Example 1 except the following changes: in (1-2) (a) Preliminary Polymerization of Referential Example 1, nPMDMS to tBnPDMS, the feed amount thereof to tBnPDMS/TEA=0.5 (mol/mol) and TEA/Ti to 5.0; and in (b) Main Polymerization, nPMDMS to CHEDMS, the feed amount thereof to CHEDMS/Ti=1.21 (mol/mol), the concentration of ethylene in the gas phase to 1.0 vol % and the concentration of hydrogen in the gas phase to 5.59 vol %. The resulting crystalline propylene-ethylene copolymer (PP3) had an ethylene content of 2.1% by weight, a CXS of 1.8% by weight, an intrinsic viscosity [η] of 1.22 dl, and a Tm of 151.0° C.

### Referential Example 5

(5-1) Polymerization of Crystalline Propylene-Ethylene Copolymer (PP5)

Crystalline propylene homopolymer (PP5) in the form of a resin powder was obtained in the same manner as Referential Example 1 except the following changes: in (1-2) (a) Preliminary Polymerization of Referential Example 1, nPMDMS to tBnPDMS, the feed amount thereof to tBnPDMS/TEA=0.1 (mol/mol) and TEA/Ti to 5.0; and in (b) Main Polymerization, nPMDMS to tBnPDMS, the feed amount thereof to tBnPDMS/Ti=1.21 (mol/mol), the concentration of ethylene in the gas phase to 1.22 vol % and the concentration of hydrogen in the gas phase to 6.44 vol %. The resulting crystalline propylene-ethylene copolymer (PP5) had an ethylene content of 2.5% by weight, a CXS of 3.5% by weight, an intrinsic viscosity [η] of 1.08 dl, and a Tm of 148.3° C.

### Example 1

(1-1) Polypropylene Resin Composition for Injection Molding

To 100 parts by weight of the crystalline propylene-ethylene copolymer (PP1) obtained in the above-described Referential Example 1, 0.05 part by weight of a phenol compound (pentaerythritol tetrakis[3-(3,5-di-tert-butyl-4-hydroxyphenyl)propionate] (IRGANOX 1010: manufactured by Ciba Specialty Chemicals) as an antioxidant and 0.05 part by weight of calcium stearate as a neutralizing agent were blended and mixed with a Henschel mixer. The resulting mixture was melt-kneaded into pellets using a single screw extruder (manufactured by Tanabe Manufacturing Co. Ltd.) 40 mm in diameter at a set temperature of 200° C. and a screw speed of 100 rpm.

(1-2) Injection Molded Article

Using an apparatus specified below, the above-mentioned pellets obtained by melt-kneading were injection molded, resulting in an injection molded article.

Apparatus: NESTAL Sycap (110 tons) manufactured by Sumitomo Heavy Industries, Ltd.

Molding temperature: 220° C.

Set mold temperature: 50° C.

(1-3) Measurements of Physical Properties

Using the injection molded article obtained, the transparency (haze), impact strength (FWI) and flexural modulus (FM) were measured. The measurements are shown in Table 1.

### Example 2

Pellets were obtained in the same manner as Example 1 except changing PP1 used in Example 1 to PP2 obtained in Referential Example 2. The pellets obtained were subjected to injection molding. The measurements of the injection molded article obtained are shown in Table 1.

### Example 3

Pellets were obtained in the same manner as Example 1 except changing PP1 used in Example 1 to PP3 obtained in Referential Example 3. The pellets obtained were subjected to injection molding. The measurements of the injection molded article obtained are shown in Table 1.

### Comparative Example 1

Pellets were obtained in the same manner as Example 1 except changing PP1 used in Example 1 to PP4 obtained in Referential Example 4. The pellets obtained were subjected to injection molding. The measurements of the injection molded article obtained are shown in Table 1.

### Comparative Example 2

Pellets were obtained in the same manner as Example 1 except changing PP1 used in Example 1 to PP5 obtained in Referential Example 5. The pellets obtained were subjected to injection molding. The measurements of the injection molded article obtained are shown in Table 1.

TABLE 1

| | |
|---|---|
| | Comparative |
| Example | Example |

| | 1 | 2 | 3 | 1 | 2 |
|---|---|---|---|---|---|
| Propylene-based | PP1 | PP2 | PP3 | PP4 | PP5 |
| polymer | | | | | |
| Amount of CXS | 7.4 | 10.7 | 7.8 | 1.8 | 3.5 |
| (wt %) | | | | | |
| Mw of CXS | 38000 | 51500 | 28900 | 11000 | 11000 |
| Mn of CXS | 5360 | 8080 | 4330 | 1370 | 2010 |
| Mw/Mn of CXS | 7.1 | 6.4 | 6.7 | 8.0 | 5.5 |
| MFR (g/10 min) | 47.0 | 30.5 | 22.3 | 35.5 | 68.9 |
| FWI (kgcm) | 131 | 131 | 114 | 3.8 | 4.3 |
| FM (MPa) | 818 | 542 | 882 | 1246 | 1118 |
| Haze (%) | 53.2 | 54.7 | 54.7 | 72.3 | 67.8 |

It is clear that Examples 1 to 3, which satisfy the requirements of the present invention, result in a superior transparency and a superior impact resistance. On the other hand, it is also clear that Comparative Examples 1 and 2, which do not satisfy the requirements of the present invention, result in a low impact resistance and a poor transparency.

### Example 4

(4-1) Polypropylene Resin Composition for Injection Molding

To 100 parts by weight of the crystalline propylene-ethylene copolymer (PP1) obtained in the above-described Referential Example 1, 0.3 part by weight of 1,3-o-methylbenzylidene 2,4-p-methylbenzylidene sorbitol (commercial name: Gelol DH, manufactured by New Japan Chemical Co., Ltd.) as a nucleating agent and 0.05 part by weight of a phenol compound (pentaerythritol tetrakis[3-(3,5-di-tert-butyl-4-hydroxyphenyl)propionate] (IRGANOX 1010: manufactured by Ciba Specialty Chemicals) as an antioxidant and 0.05 part by weight of calcium stearate as a neutralizing agent were blended and mixed with a Henschel mixer. The resulting mixture was melt-kneaded into pellets using a single screw extruder (manufactured by Tanabe Manufacturing Co. Ltd.) 40 mm in diameter at a set temperature of 200° C. and a screw speed of 100 rpm.

(4-2) Injection Molded Article

Using an apparatus specified below, the above-mentioned pellets obtained by melt-kneading were injection molded, resulting in an injection molded article.

Apparatus: NESTAL Sycap (110 tons) manufactured by Sumitomo Heavy Industries, Ltd.

Molding temperature: 220° C.

Set mold temperature: 50° C.

(4-3) Measurements of Physical Properties

Using the injection molded article obtained, the transparency (haze), impact strength (FWI) and flexural modulus (FM) were measured. The measurements are shown in Table 2.

### Example 5

Pellets were obtained in the same manner as Example 1 except changing PP1 used in Example 1 to PP2 obtained in Referential Example 4. The pellets obtained were subjected to injection molding. The measurements of the injection molded article obtained are shown in Table 2.

### Comparative Example 3

Pellets were obtained in the same manner as Example 4 except not using Gelol DH used in Example 4. The pellets obtained were subjected to injection molding. The measurements of the injection molded article obtained are shown in Table 2.

### Comparative Example 4

Pellets were obtained in the same manner as Example 4 except not using Gelol DH used in Example 4. The pellets obtained were subjected to injection molding. The measurements of the injection molded article obtained are shown in Table 2.

### Comparative Example 5

Pellets were obtained in the same manner as Example 4 except changing PP1 used in Example 4 to PP4 obtained in Referential Example 4. The pellets obtained were subjected to injection molding. The measurements of the injection molded article obtained are shown in Table 2.

### Comparative Example 6

Pellets were obtained in the same manner as Example 4 except changing PP1 used in Example 4 to PP5 obtained in Referential Example 5. The pellets obtained were subjected to injection molding. The measurements of the injection molded article obtained are shown in Table 2.

TABLE 2

| | Example | | Comparative Example | | | |
|---|---|---|---|---|---|---|
| | 4 | 5 | 3 | 4 | 5 | 6 |
| Propylene-baesd polymer | PP1 | PP2 | PP1 | PP2 | PP4 | PP5 |
| (1) (part by weight) | (100) | (100) | (100) | (100) | (100) | (100) |
| Nucleating agent | G-DH | G-DH | No | No | G-DH | C-DH |
| (part by weight) | (0.3) | (0.3) | | | (0.3) | (0.3) |
| Amount of CXS of (1) | 7.4 | 10.7 | 7.4 | 10.7 | 1.8 | 3.5 |
| (wt%) | | | | | | |
| Mw of CXS of (1) | 38000 | 515000 | 38000 | 51500 | 11000 | 11000 |
| Mn of CXS of (1) | 5360 | 8080 | 5360 | 8080 | 1370 | 2010 |
| Mw/Mn of CXS of (1) | 7.1 | 6.4 | 7.1 | 6.4 | 8.0 | 5.5 |
| MFR (g/10 min) | 49.2 | 31.3 | 47.0 | 30.5 | 35.9 | 70.6 |
| FWI (kgcm) | 102 | 133 | 131 | 131 | 1.9 | 1.7 |
| Haze (%) | 9.1 | 7.8 | 53.2 | 54.7 | 10.9 | 10.1 |
| FM | 915 | 583 | 818 | 542 | 1444 | 1264 |

It is clear that Examples 4 and 5, which satisfy the requirements of the present invention, result in superior transparencies and superior impact resistances. On the other hand, it is also clear that Comparative Examples 3 and 4, which do not satisfy the requirements of the present invention, result in low impact resistances and poor transparencies and that Comparative Examples 5 and 6 result in low impact strengths.

As described in detail above, according to the present invention, a propylene-based polymer for injection molding superior in transparency and impact resistance and an injection molded article made of the same can be obtained.

What is claimed is:

1. A propylene-based polymer satisfying requirements (a) and (b) defined below:
(a) the proportion of a fraction soluble in xylene at 20° C. (CXS) relative to the whole propylene-based polymer is from 5 to 20% by weight; and
(b) the CXS has a molecular weight distribution (Mw/Mn), as measured by gel permeation chromatography, of 6 or more wherein Mw indicates a weight average molecular weight and Mn indicates a number average molecular weight.

2. A propylene-based resin composition comprising a propylene-based polymer satisfying requirements (a) and (b) defined below and from 0.001 to 2 parts by weight, based on 100 parts by weight of the propylene-based polymer, of a nucleating agent:
(a) the proportion of a fraction soluble in xylene at 20° C. (CXS) relative to the whole propylene-based polymer is from 5 to 20% by weight; and
(b) the CXS has a molecular weight distribution (Mw/Mn), as measured by gel permeation chromatography, of 6 or more wherein Mw indicates a weight average molecular weight and Mn indicates a number average molecular weight.

3. An injection molded article made of a propylene-based polymer, the polymer satisfying requirements (a) and (b) defined below:
(a) the proportion of a fraction soluble in xylene at 20° C. (CXS) relative to the whole propylene-based polymer is from 5 to 20% by weight; and
(b) the CXS has a molecular weight distribution (Mw/Mn), as measured by gel permeation chromatography, of 6 or more wherein Mw indicates a weight average molecular weight and Mn indicates a number average molecular weight.

4. An injection molded article comprising a propylene-based resin composition, the composition comprising a propylene-based polymer satisfying requirements (a) and (b) defined below and from 0.001 to 2 parts by weight, based on 100 parts by weight of the propylene-based polymer, of a nucleating agent:
(a) the proportion of a fraction soluble in xylene at 20° C. (CXS) relative to the whole propylene-based polymer is from 5 to 20% by weight; and
(b) the CXS has a molecular weight distribution (Mw/Mn), as measured by gel permeation chromatography, of 6 or more wherein Mw indicates a weight average molecular weight and Mn indicates a number average molecular weight.
